(19) United States
(12) Patent Application Publication
(10) Pub. No.: US 2021/0357781 A1
(43) Pub. Date: Nov. 18, 2021

(54) EFFICIENT TECHNIQUES FOR DETERMINING THE BEST DATA IMPUTATION ALGORITHMS

(71) Applicant: International Business Machines Corporation, Armonk, NY (US)

(72) Inventors: Arun Kwangil IYENGAR, Yorktown Heights, NY (US); Dhavalkumar C. PATEL, White Plains, NY (US)

(21) Appl. No.: 16/875,533

(22) Filed: May 15, 2020

(51) Int. Cl. G06N 5/04; G06F 17/17

(52) U.S. Cl. CPC G06N 5/04; G06F 17/17

(57) ABSTRACT

A processing system, a computer program product, and a method for efficiently determining a best imputation algorithm from a plurality of imputation algorithms A method includes: providing a plurality of imputation algorithms; providing a time parameter tmax to limit an amount of time spent determining a best imputation algorithm; maintaining past information i on accuracy and execution time for at least one of the imputation algorithms; using said information i to compute a utility score for each of the at least one the imputation algorithms; and testing imputation algorithms and associated parameters in an order based on said utility scores.

### BACKGROUND

The present invention generally relates to data analytics methods operating in computer systems, and more particularly relates to data imputation methods operating in a computer system.

Data imputation is critically important for determining missing values in data sets. There are a wide variety of data analytics algorithms. A key point is that there is no algorithm which will always work best. The best algorithm is dependent on the data sets as well as the criteria used for selecting the best algorithm Prediction accuracy as well as computational overhead may both need to be considered, and there is often a trade-off between the two.

Many data sets contain missing values. In order to handle the missing values, data imputation is frequently used to estimate missing values. A wide variety of data imputation techniques have been proposed in the literature for imputing missing values. Simple techniques such as mean, median, and mode are easy to implement and do not incur significant overhead. More sophisticated techniques such as multiple imputation using chained equations can result in better accuracy but with higher overhead. Other techniques such as neural nets have also been used for data imputation.

Given the wide range of data imputation algorithms that are available, methods are needed to determine the best ones. The best algorithm is highly dependent on the data set. In addition, multiple criteria can be used to determine the best data imputation algorithms. Accuracy is important as is execution time. There is often a trade-off between these criteria. Algorithms which result in higher accuracy may have higher overhead.

### BRIEF SUMMARY

According to one embodiment, a computer-implemented method for: providing a plurality of imputation algorithms; providing a time parameter tmax to limit an amount of time spent determining a best imputation algorithm; maintaining past information i on accuracy and execution time for at least one of the imputation algorithms; using said information i to compute a utility score for each of the at least one the imputation algorithms; and testing imputation algorithms and associated parameters in an order based on said utility scores.

According to one embodiment, a computer program product for efficiently determining a best imputation algorithm from a plurality of imputation algorithms, the computer program product comprising a computer readable storage medium having computer readable program code embodied therewith, the computer readable program code including computer instructions, where a processor, responsive to executing the computer instructions, performs operations comprising: providing an error threshold e for an imputation algorithm; maintaining past information i on prediction accuracy for the imputation algorithm; identifying a data set d1 from i and a subset s1 of d1 wherein an average error for running the imputation algorithm on s1 differs from an average error for running the imputation algorithm on d1 by an amount not exceeding e; and using s1 or a size of s1 to determine prediction accuracy for the imputation algorithm on a data set d2.

According to one embodiment, a processing system comprises: a server for a cloud computing infrastructure communicatively coupled to a network interface; one or more processors communicatively coupled to the server; a memory coupled to a processor of the one or more processors; and a set of computer program instructions stored in the memory, wherein the processor, responsive to executing computer program instructions, performs the method comprising: providing a plurality of imputation algorithms; providing a time parameter tmax to limit an amount of time spent determining a best imputation algorithm; maintaining past information i on accuracy and execution time for at least one of the imputation algorithms; using said information i to compute a utility score for each of the at least one the imputation algorithms; and testing imputation algorithms and associated parameters in an order based on said utility scores.

### BRIEF DESCRIPTION OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating an example of a method for determining accuracy of data imputation algorithms in a processing system, according to various embodiments of the present invention;

FIG. 2 is a block diagram illustrating another example of a method for determining accuracy of data imputation algorithms in a processing system, according to various embodiments of the present invention;

FIG. 3 is a block diagram illustrating an example processing system server node operating in a network environment, according to an embodiment of the present invention;

FIG. 4 depicts a cloud computing environment suitable for use with an embodiment of the present invention;

FIG. 5 depicts abstraction model layers according to the cloud computing embodiment of FIG. 4;

FIG. 6 is an operational flow diagram for a processing system performing a first example method for determining a best data imputation method by considering multiple criteria, according to an embodiment of the present invention;

FIG. 7 is an operational flow diagram for a processing system performing a second example method for determining a best data imputation method by considering multiple criteria, according to an embodiment of the present invention;

FIG. 8 is an operational flow diagram for a processing system performing a first example method for efficiently determining a best data imputation method, according to an embodiment of the present invention; and

FIG. 9 is an operational flow diagram for a processing system computing a smaller data set for determining behavior of a data imputation method.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The terminology used herein is for the purpose of describing particular embodiments only and is not intended to be limiting of the invention.

Various embodiments of the present invention are applicable to data analytics systems operating in a wide variety of computing environments including cloud environments and non-cloud environments.

The inventors have discovered and hereby present a BestImputer data analytics system for automatically determining the best data imputation methods (e.g., which may also be referred to herein as imputation algorithms) out of several. BestImputer provides a wide variety of imputation algorithms to test. It also provides a modular architecture for selecting different algorithms, parameters, and methods for testing data imputation algorithms.

BestImputer allows multiple parameters associated with an imputation method to be varied including, but not limited to:

Imputation algorithms to test;

Parameters passed to imputation algorithms;

Methods for deleting data for testing imputation algorithms; and

Methods for evaluating accuracy of imputation algorithms.

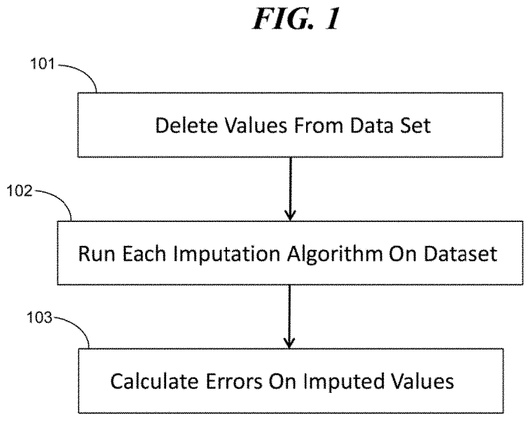

BestImputer has multiple methods for determining the accuracy (in this specification, accuracy of imputation algorithms is synonymous with prediction accuracy) of imputation algorithms. A first approach is to take a data set, delete known values from the data set, and impute the deleted known values. The accuracy of the imputation algorithms can then be determined using techniques such as mean absolute error and mean squared error, such as discussed herein with reference to FIG. 1.

The accuracy of an imputation algorithm will depend on the way that known data values are deleted from the data set. BestImputer provides capabilities to delete known values completely at random. It also allows data to be deleted with higher probability for specific rows or columns. This approach would be applicable when certain fields or records have a higher probability of incurring missing values. Users can also provide their own customized methods for deleting specific known data values for testing the accuracy of data imputation.

We also allow the number of known data values to be deleted to be varied. This quantity can be specified as either an absolute number or a proportion of total data values. It is advisable to test different proportions of missing data values to get a more complete assessment of the accuracy of a data imputation algorithm.

Since the process of deleting data values can be random, according to certain examples, the results will vary depending on the specific data values which are deleted. It is therefore advisable to run several experiments by deleting different sets of data values and average the results to more accurately compare different data imputation algorithms.

Patterns of missing data may fall into three different categories: missing completely at random (MCAR), missing at random (MAR), and missing not at random (MNAR). If the data are MCAR, then the probability of a data point to be missing is independent of any values in the data set whether they are missing or observed. If the data are MAR, then the probability of a data point to be missing is dependent on some of the observed data but not on any of the missing data. If the data are MNAR, then the probability of a data point being missing is dependent on the actual data point.

BestImputer takes a wide variety of data imputation algorithms including, but not limited to, mean, median, mode (most frequent), MICE, k nearest neighbors, MissForests, iterative imputation algorithms, and several other possibilities. BestImputer also provides the capability to test a wide variety of different parameter settings for imputation methods.

Imputation algorithms often have parameters which affect both the accuracy and computational overhead of the algorithms. We allow parameters to be specified using parameter grids. For each imputation algorithm, we also provide a set of recommended (e.g., which may also be referred to as default) parameter settings to try based on our knowledge of the imputation algorithm.

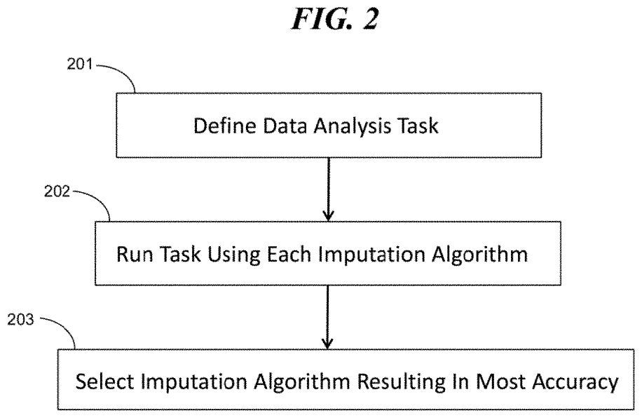

A second approach BestImputer provides is to take an end-to-end prediction task and to see how well different imputation algorithms perform on the end-to-end prediction task. For example, a user may be performing regression or classification on a data set with missing values. Data imputation would be performed on the data set before the regression or classification analysis is applied. The best data imputation algorithm is the one which results in the highest classification or regression accuracy, such as discussed herein with reference to FIG. 2.

These two approaches are complementary. The second approach is a more task-specific approach in which the best imputation algorithm is associated with the predictive task being performed. The following discussion will reference FIG. 2.

At step 201, an end-to-end data analysis task is defined. As an example, this data analysis task could include obtaining data from a source, filtering and/or cleansing the data, scaling the data, imputing missing data values, and classifying input data values into one of a plurality of classes using a variety of classification algorithms and parameter settings. K-fold cross-validation could be used to select a best classification algorithm (and parameter setting). The input data includes missing values which are to be imputed.

At step 202, the analysis task defined in step 201 is performed using a variety of different imputation algorithms and parameter settings for those algorithms. Note that each execution of the analytics task invokes multiple classification algorithms wherein the classification algorithms may also be run with different parameter settings.

At step 203, we determine which data imputation algorithm (and associated parameter settings, if any) result in the highest accuracy on the predictive task. In general, a variety of methods can be used for determining accuracy on the predictive task. An exemplary approach in this example is to pick the data imputation algorithm with the least cross-validation error.

A wide variety of other end-to-end data analytics tasks can be used in the method depicted in FIG. 2. For example, the data analytics task could involve, regression and/or clustering, as well as classification.

The computational overhead consumed by a data imputation algorithm can be significant. The overhead is compounded by the fact that several imputation algorithms need to be tested to determine the best ones. An imputation algorithm may have several parameters which need to be varied. Furthermore, an imputation algorithm with a given set of parameters will typically need to be run on several data sets with missing values in order to accurately assess the performance of the imputation algorithm. The overhead of a data imputation algorithm can grow with the size of the data.

Computational overhead is thus an important criterion to use for evaluating a data imputation algorithm. In several cases, there is a trade-off between accuracy and computational overhead. Algorithms which result in the highest degree of accuracy may have higher computational overhead.

BestImputer provides a wide variety of data imputation algorithms. Simple imputation algorithms include mean, median, and mode.

BestImputer also supports more sophisticated data imputation algorithms including, but not limited to, multiple imputation algorithms such as multiple imputation using chained equations. In multiple imputation, several data sets are calculated for missing values. These multiple data sets can then be combined appropriately to predict missing values.

MICE is a multiple imputation algorithm which works best when data are MAR or MCAR. Missing values for each variable can be computed using regression over other variables in the data set. The process can be repeated multiple times.

In MICE, missing values for a variable can be determined by performing regression using one or more other variables as co-variates.

Multiple criteria may be used for evaluating data imputation algorithms. These include, but are not limited, to: prediction accuracy, wall clock time for performing imputations, total execution time for performing imputations, and others. Furthermore, users can customize criteria for evaluating imputation algorithms. Wall clock time for performing imputations can often be reduced by performing parallel computations. By contrast, total execution time for performing imputations will not be reduced by parallel computations.

Prediction accuracy and computational overhead are important criteria for evaluating imputation algorithms. There is often a trade-off between these criteria. Greater prediction accuracy can be achieved at a cost of higher computational overhead.

There are multiple ways to measure prediction accuracy. For example, the method of FIG. 1 can be used with different ways of deleting known data values, as well as with differing amounts of deleted data. The method of FIG. 2 can also be used with different end-to-end analytics tasks. There are also multiple ways of measuring errors between actual values and predicted values. Ways of measuring errors include, but are not limited to, mean absolute error, mean squared error, and user-specified error functions.

According to various embodiments of the invention, BestImputer can consider multiple criteria in determining a best data imputation algorithm. For example, BestImputer can consider both imputation accuracy and computational overhead. Greater accuracy increases the desirability of a data imputation algorithm, while higher computational overhead decreases the desirability.

Suppose that e(i) is the prediction error for imputation algorithm i and t(i) is the execution time for imputation algorithm i. A score for imputation algorithm i can be assigned using the formula:

S(i)=a*e(i)+b*t(i)

where a and b are both negative numbers. BestImputer can assign such scores to all imputation algorithms being considered and pick the imputation algorithm with the highest score. [Note that the scoring function can also be defined in a manner in which a best imputation algorithm has a lowest score. This may be the case if a and b are both positive numbers]. This is an example of picking a best imputation algorithm by considering both prediction accuracy and computational overhead.

One approach for determining a best data imputation algorithm by considering multiple criteria will be discussed below, with reference to FIGS. 1, 2, and 6.

BestImputer provides a plurality of criteria for evaluating imputation algorithms. These may include, but are not limited, to criteria correlated with prediction accuracy and computational overhead. As we mentioned previously, there are multiple ways of determining prediction accuracy, including, but not limited to, the methods depicted in FIGS. 1 and 2. FIG. 1 encompasses a wide range of specific method of determining accuracy. For example, different strategies can be used for deleting data values in step 101 (e.g. vary amount of missing data, use different approaches for determining data values to delete). Furthermore, different methods can be used for calculating errors on imputed values in step 103 (e.g. mean squared error, mean average error, etc.). FIG. 2 also encompasses a wide range of specific methods for determining accuracy. For example, a wide variety of data analysis tasks can be used in step 201. Furthermore, different methods can be used for determining the accuracy of the data analysis task in step 203. There are also multiple methods of determining computational overhead including wall clock time for performing imputations, total execution time for performing imputations, and other methods.

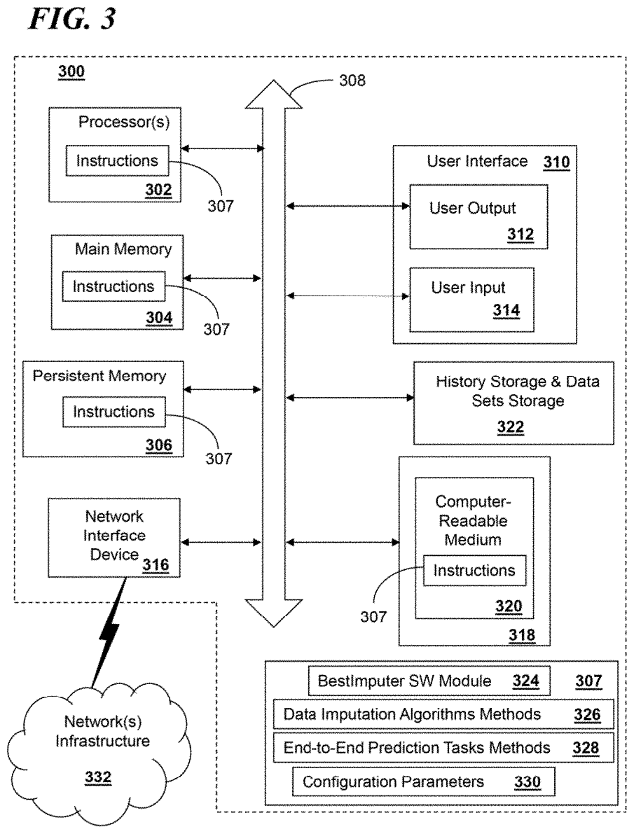

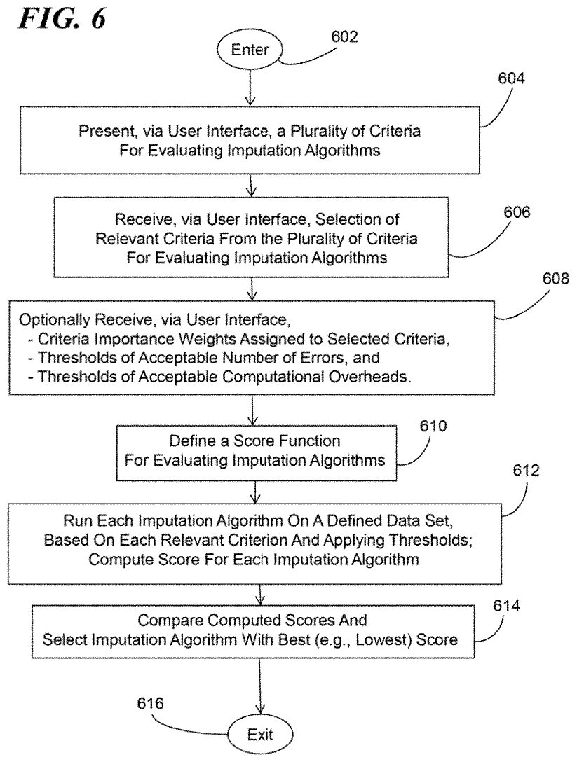

According to the example method shown in FIG. 6, which is entered at step 602 and proceeds to steps 604 and 606, users can select n criteria out of the total criteria that they are interested in. One example way is by presenting via a user output interface 310 (e.g., displaying) a plurality of criteria choices (see FIG. 3), and receiving user input via a user input interface 314 (e.g., receiving information entered via typing on a keyboard and/or selected by operation of a mouse device).

The operations continue, at step 608, in which users can optionally assign weights aᵢ correlated with importance of criteria. Default weights exist.

Users can optionally assign thresholds tᵢ representing acceptable errors, computational overheads, etc. Default thresholds are 0, in the example.

BestImputer, at step 610, defines a score:

S=Σᵢ₌₁ⁿaᵢ*max(eᵢ−tᵢ,0)

where:

S is the score for the imputation algorithm;

n is the number of criteria;

a₁ is the weight of criterion i;

eᵢ is the error (or computational overhead) for criterion i determined by BestImputer; and

tᵢ is the threshold of criterion i.

The best imputation algorithm, according to the example, is the one with the lowest score.

Note that it is also possible to define scoring functions (analogous to S) within the scope of this invention wherein higher scores correspond to better imputation algorithms. One such example would be to multiply S by −1.

It is also possible to define error functions (analogous to eᵢ) within the scope of this invention wherein nonzero errors are negative values, with higher errors corresponding to lower values. One such example would be to multiply eᵢ by −1.

As an example, n could be 4 with the following criteria.

Criterion 1: Prediction accuracy is determined using the method in FIG. 1 deleting 10% of data values selected completely at random in step 101. In step 103, an error value for each imputation algorithm is determined by computing mean squared errors for the imputed values and normalizing the error value for each imputation algorithm to a value between 0 and 1.

Criterion 2: Prediction accuracy is determined using the method in FIG. 1 deleting 40% of data values selected completely at random in step 101. In step 103, an error value for each imputation algorithm is determined by computing mean squared errors for the imputed values and normalizing the error value for each imputation algorithm to a value between 0 and 1.

Criterion 3: The wall clock time is determined for running each data imputation algorithm when determining values for criterion 1. These wall clock times are normalized to values between 0 and 1.

Criterion 4: The wall clock time is determined for running each data imputation algorithm when determining values for criterion 2. These wall clock times are normalized to values between 0 and 1.

a₁=0.4

a₂=0.4

a₃=0.1

a₄=0.1

All threshold values are 0.

BestImputer runs, at steps 612 and 614, each imputation algorithm on a defined data set, based on each relevant criterion and applying defined thresholds, and then computes a score for each imputation algorithm. BestImputer compares the computed scores and selects an imputation algorithm with the best score. This best score may be a lowest score, a highest score, or another more complex metric defining the relative operation of the alternative data imputation algorithms with respect to one or more data sets of interest. Note that a wide variety of other criteria, weights, and thresholds can be used within this framework. The BestImputer operational method is then exited, at step 616.

Another approach for determining a best data imputation algorithm by considering multiple criteria will be discussed below, with reference to FIGS. 1, 2, and 7.

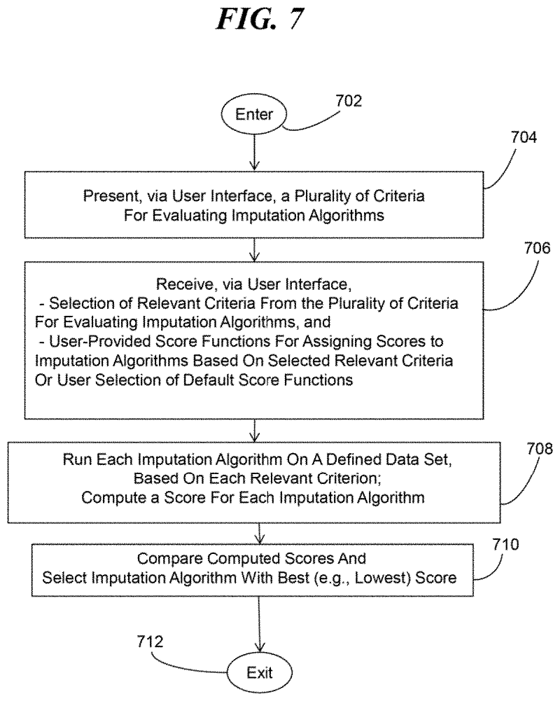

According to the example method shown in FIG. 7, which is entered at step 702 and proceeds to steps 704 and 706, BestImputer provides (e.g., by displaying information via a user output interface 312) a plurality of criteria for evaluating imputation algorithms. These may include, but are not limited, to criteria correlated with prediction accuracy and computational overhead. As we mentioned previously, there are multiple ways of determining prediction accuracy, including, but not limited to, the methods depicted in FIGS. 1 and 2. There are also multiple methods of determining computational overhead.

Users can select, at step 706, n criteria (e.g., n relevant criteria) out of the total criteria that they are interested in.

Users provide functions for assigning scores to imputation algorithms based on the criteria selected in the step. BestImputer provides default functions for assigning scores to imputation algorithms which users can select from as well. One example way is by presenting via a user output interface 310 (e.g., displaying) a plurality of criteria choices (see FIG. 3), and receiving user input via a user input interface 314 (e.g., receiving information entered via typing on a keyboard and/or selected by operation of a mouse device). BestImputer runs, at steps 708 and 710, each imputation algorithm on a defined data set, based on each relevant criterion and applying defined thresholds, and then computes a score for each imputation algorithm. BestImputer compares the computed scores and selects an imputation algorithm with the best score. This best score may be a lowest score, a highest score, or another more complex metric defining the relative operation of the alternative data imputation algorithms with respect to one or more data sets of interest.

In the present example, the best imputation algorithm is the one with the lowest score.

For example, n could be 4 with the following criteria.

Criterion 1: Prediction accuracy is determined using the method in FIG. 1 deleting 8% of data values selected completely at random in step 101. In step 103, an error value e1 for each imputation algorithm is determined by computing mean average errors for the imputed values and normalizing the error value for each imputation algorithm to a value between 0 and 1.

Criterion 2: Prediction accuracy is determined using the method in FIG. 1 deleting 35% of data values selected completely at random in step 101. In step 103, an error value e2 for each imputation algorithm is determined by computing mean average errors for the imputed values and normalizing the error value for each imputation algorithm to a value between 0 and 1.

Criterion 3: The wall clock time is determined for running each data imputation algorithm when determining values for criterion 1. These wall clock times are normalized to values between 0 and 1, resulting in a value t1 for each data imputation algorithm.

Criterion 4: The wall clock time is determined for running each data imputation algorithm when determining values for criterion 2. These wall clock times are normalized to values between 0 and 1, resulting in a value of t2 for each data imputation algorithm.

BestImputer computes, according to this example, a score for each data imputation algorithm using a function: e1+e2+(t1*t1)+(t2*t2). Note that a wide variety of other functions can be used for assigning scores to data imputation algorithms within this framework. The BestImputer operational method is then exited, at step 712.

An issue is that determining best data imputation algorithms can be computationally expensive. The computational overhead typically increases with data sizes. When the method in FIG. 1 is used, the accuracy of imputation algorithms typically varies depending on the way that values are deleted from the data set in step 101. Because of this, it is desirable to run the approach in FIG. 1 multiple times for the same imputation algorithm but deleting different sets of data values in step 101. The error values can then be averaged over these multiple runs. Performing multiple runs of this nature adds computational overhead.

Iterative data imputation techniques like missForests can have considerably higher overhead than simpler techniques such as mean. With missForests, a column is typically imputed from several other columns multiple times. Random forests are used for regression which typically has higher overhead than linear regression.

Finding the best data imputation algorithms involves running each of the algorithms to compare their accuracy (and possibly performance as well). Multiple parameter settings may also need to be tested.

As a result, it is desirable to determine the best data imputation algorithms by minimizing computational overhead. BestImputer has several features for minimizing computational overhead.

Users can provide an upper bound, tmax, on the execution time spent by BestImputer to determine a best data imputation algorithm. This execution time could be wall clock time, cpu time, or another metric correlated with computational overhead.

In addition, an upper bound, tmax(i), can be specified for the execution time for BestImputer to evaluate any particular data imputation algorithm i. BestImputer uses knowledge that it has on execution times of imputation algorithms to determine how to detect best imputation algorithms without violating overhead constraints specified by tmax and/or tmax(i) values.

BestImputer maintains data, which is empirical evidence of prediction accuracy and execution times, for multiple data imputation algorithms and parameter settings in a Data Analysis Results Repository (DARR). This may also be referred to herein as a History Storage. The DARR is maintained over an extended period of time. As BestImputer tests out different data imputation algorithms, it stores accuracy and execution times for those algorithms in the DARR. The DARR is constantly updated as BestImputer executes. The DARR allows BestImputer to make intelligent choices of which data imputation algorithms and parameter settings to try.

Examples of the empirical evidence maintained in the DARR include, but are not limited, to:

Computational time for past executions of data imputation algorithms with key parameter settings as a function of:

number of records in a data set;

number of features;

amount of missing data;

prediction accuracy and computational time as a function of parameter value for several key parameters, including:

For MICE algorithms: number of iterations;

For k nearest neighbors algorithms: k; or

For random-forest based imputers:

number of trees in the forest; or

number of features to consider when looking for the best split.

BestImputer can use the DARR in the following way to determine the best data imputation algorithms when computational overhead is limited. The DARR contains past information on the accuracy and performance of several imputation algorithms along with associated parameter settings. BestImputer can examine the DARR to determine data imputation algorithms and parameter settings likely to result in the most accuracy which do not consume too much time. BestImputer can assign a utility score, U, to each data imputation algorithm A with parameter set X, U(A(X)). U is computed from past data on data imputation algorithm A stored in the DARR. U(A(X)) increases as the expected prediction accuracy of A(X) increases but decreases as the expected computational overhead of A(X) increases.

If e1 is the expected mean squared error for A(X) and t1 is the expected execution time for A(X), then one possible formula would be U(A(X))=a*e1+b*t1, where both a and b are negative numbers. A wide variety of other formulas can be used by BestImputer as well.

BestImputer can order imputation algorithms A and associated parameter settings X by decreasing U(A(X)) values. BestImputer can then test out different imputation algorithms and associated parameter settings, A(X), in decreasing order of U values while making sure that if tmax(A) is specified for any imputation algorithm, the total time spent executing A does not exceed tmax(A). BestImputer stops trying to find a best imputation algorithm before the total execution time for all algorithms exceeds tmax.

There are multiple methods that BestImputer can use for determining execution time, including, but not limited to, wall clock time and CPU time.

In some cases, tmax and/or tmax(i) values are not strict. BestImputer is allowed to exceed them by a small amount. If the tmax value is approximate but not strict, BestImputer can finish a last data imputation computation even if this causes the total execution time to slightly exceed tmax. If tmax(i) for an imputation algorithm i is approximate but not strict, BestImputer can finish a last data imputation computation using algorithm i even if the total execution time on that particular algorithm slightly exceeds tmax(i).

By contrast, if tmax or a tmax(i) value is strict, BestImputer may have to stop an imputation computation before it is complete to prevent tmax or tmax(i) from being exceeded. An alternative approach is to not start a new data imputation computation when total execution time is below tmax (or execution time for imputation algorithm i is only slightly below tmax(i)) but close enough that running and completing a new imputation computation could cause tmax or tmax(i) to be exceeded. These two alternatives can be used separately or together.

More specifically, a second threshold, t3, could be used to prevent total execution time from exceeding tmax. Once total execution time exceeds tmax—t3, BestImputer does not perform additional imputation computations.

Second thresholds, t3(i), can also be maintained for specific data imputation algorithms i. Once execution time for data imputation algorithm i exceeds tmax—t3(i), BestImputer does not perform additional imputation computations using data imputation algorithm i.

BestImputer thus can use, according to various embodiments, the following example way to efficiently determine a best data imputation method. The discussion below will be with reference to FIGS. 1, 2, and 8.

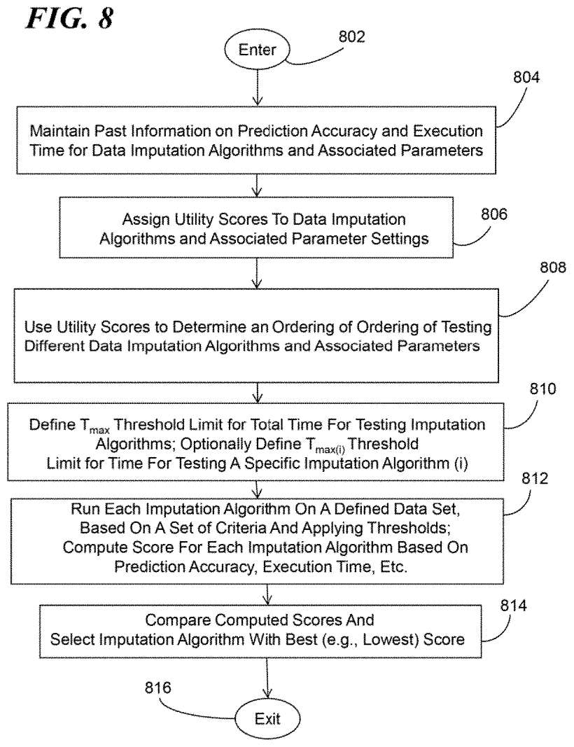

According to the example method shown in FIG. 8, which is entered at step 802 and proceeds to steps 804 and 806, BestImputer maintains past information (e.g., history information) on prediction accuracy and execution time for data imputation algorithms and associated parameter settings in the DARR 322. This may also be referred to herein as a History Storage 322.

BestImputer assigns utility scores to data imputation algorithms and associated parameter settings based on this history information in the DARR 322.

BestImputer, at step 808, uses the utility scores to determine an ordering for testing different data imputation algorithms and associated parameter settings.

BestImputer, at step 810, uses tmax to limit the total time testing imputation algorithms. If tmax(i) is specified for imputation algorithm i, BestImputer uses tmax(i) to limit the amount of time for testing imputation algorithm i.

After BestImputer, at steps 812 and 814, has finished testing imputation algorithms, BestImputer picks a best imputation method (e.g., imputation algorithm) along with an associated set of parameters. The best imputation algorithm can be determined in multiple ways. For example, it can be based on prediction accuracy. In addition, it can be determined based on multiple criteria, such as prediction accuracy, execution time, etc. Earlier, with reference to FIGS. 6 and 7, we described exemplary methods for determining a best imputation algorithm based on multiple criteria. Similar methods can be applied here. For example, BestImputer, at step 812, can assign a score to different imputation algorithms using similar formulas to the ones described earlier and, at step 814, use these scores to pick a best data imputation algorithm. The BestImputer operational method is then exited, at step 816.

Another feature that BestImputer provides is that users can also specify imputation algorithms to test out. Users can also specify parameter settings associated with the specified imputation algorithms. These user-specified imputation algorithms and settings can be tested by BestImputer, as well as the algorithms and settings that BestImputer determines are the most important to test based on the contents of the DARR.

The overhead of data imputation algorithms generally increases with the size of the data. If BestImputer can determine a best data imputation algorithm while performing at least some imputations on a fraction of the data set instead of the whole data set, this can reduce overhead compared with always using the complete data set.

In determining best imputation algorithms, the same imputation algorithm may have to be run multiple times using different parameter values as well as with different input data sets containing missing values. An error threshold, e(i) can be specified for each imputation algorithm i. e(i) can be provided by users. Alternatively, BestImputer can provide default value(s) for e(i). As described earlier, when data imputation is performed on a data set, an error value can be determined (using a variety of different methods, including but not limited to mean squared error and mean average error) representing the difference between actual and imputed values. We define an error difference, ed(i) for each algorithm, where ed(i)=|e_full−e_smaller| where e_full is the average error on the full data set and e_smaller is the average error on the smaller data set. If ed(i) is less than or equal to e(i), it is acceptable to use the smaller data set to estimate errors for data imputation algorithm i. This will be more efficient than using the full data set.

Below will be discussed an example method that BestImputer can use to determine smaller input data set sizes for testing imputation algorithms. The discussion below will be with reference to FIGS. 1, 2, and 9.

Let d1 be the full input data set. The key idea is to use a smaller subset of d1 to determine the best data imputation algorithm. We now explain how to compute this smaller subset.

Error thresholds e(i) are optionally specified by users. Default error threshold values can also be provided by BestImputer. A user can select default error threshold value(s) or can specify the error threshold value(s), for use by BestImputer to determine the best data imputation algorithm.

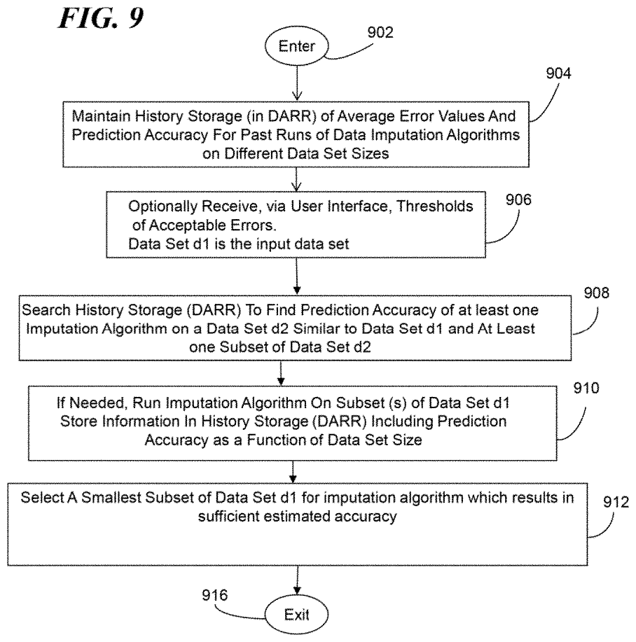

According to the example method shown in FIG. 9, which is entered at step 902 and proceeds to steps 904 and 906, BestImputer maintains past information (e.g., history information) on average error values for previous runs of data imputation algorithms on different data set sizes. BestImputer can obtain at least some of this history information from the DARR 322. BestImputer can also obtain at least some of this history information by running imputation algorithms on reduced versions of input data sets. Error thresholds e(i) are optionally specified, at step 906, by users using the user interface 310 as has been discussed above. Default error threshold values can also be provided by BestImputer, e.g., via the user interface 310, to be selected by the users, or automatically set to default values by BestImputer.

As BestImputer, at step 908, runs additional imputation algorithms to determine the best ones, it can store updated history information about prediction accuracy as a function of size in the DARR 322.

When BestImputer chooses to run data imputation algorithm i, it does not necessarily have to run i on the entire input data set d1. Instead, it may find in step 908 a data set d2 similar to data set d1 for which the DARR 322 contains history information on imputation accuracy for data set d2 and for at least one subset of data set d2. Ideally, data set d2 is identical to data set d1. For example, BestImputer might previously have run data imputation algorithm i on data set d1 as well as subsets of d1 using a different set of parameters, and the results from these previous runs are stored in the DARR 322. In other cases, data set d2 is similar to data set d1 but not identical to d1.

BestImputer, at step 912, determines that data set s3 is a smallest subset of data set d2 for which: (1) the average imputation error for at least one past run using s3 as input to imputation algorithm i is stored as history information in the DARR, and (2) the difference between the average imputation error when imputation algorithm i is run on data set s3 and the average imputation error when imputation algorithm i is run on data set d2 is less than or equal to error threshold e(i).

If data set d1 and data set d2 are identical, BestImputer runs imputation algorithm i on data set s3.

If data set d1 and data set d2 are not identical, according to the example, then BestImputer computes size_2=round(size(d1)*size(s3)/size(d2)), where round( ) rounds numbers to a nearest integer. BestImputer runs imputation algorithm i on a subset of d1 of size size_2. The BestImputer operational method is then exited, at step 916.

Reducing input data sizes in this fashion can allow more imputation algorithms to be tried, with a larger number of parameter settings, than using the full data set as input.

Example of a Processing System Server Node Operating in a Network

FIG. 3 illustrates an example of a processing system server node 300 (also referred to as a computer system/server or referred to as a server node) suitable for use to perform the example methods discussed above. The server node 300, according to the example, is communicatively coupled with a cloud infrastructure 332 that can include one or more communication networks. The cloud infrastructure 332, for example, can be communicatively coupled with a storage cloud (which can include one or more storage servers) and with a computation cloud (which can include one or more computation servers). This simplified example is not intended to suggest any limitation as to the scope of use or function of various example embodiments of the invention described herein.

The server node 300 comprises a computer system/server, which is operational with numerous other general purpose or special purpose computing system environments or configurations. Examples of well-known computing systems, environments, and/or configurations that may be suitable for use with such a computer system/server include, but are not limited to, personal computer systems, server computer systems, thin clients, thick clients, hand-held or laptop devices, multiprocessor systems, microprocessor-based systems, set top boxes, programmable consumer electronics, network personal computers (PCs), minicomputer systems, mainframe computer systems, and distributed cloud computing environments that include any of the above systems and/or devices, and the like.

The computer system/server or server node 300 may be described in the general context of computer system executable instructions, such as program modules, being executed by a computer system. Generally, program modules may include methods, functions, routines, programs, objects, components, logic, data structures, and so on that perform particular tasks or implement particular abstract data types. A computer system/server may be practiced in distributed cloud computing environments where tasks are performed by remote processing devices that are linked through a communications network. In a distributed cloud computing environment, program modules may be located in both local and remote computer system storage media including memory storage devices.

Referring more particularly to FIG. 3, the following discussion will describe a more detailed view of an example cloud infrastructure server node embodying at least a portion of a server processing system. According to the example, at least one processor 302 is communicatively coupled with system main memory 304 and persistent memory 306.

A bus architecture 308 facilitates communicative coupling between the at least one processor 302 and the various component elements of the server node 300. The bus architecture 308 represents one or more of any of several types of bus structures, including a memory bus, a peripheral bus, an accelerated graphics port, and a processor bus or local bus using any of a variety of bus architectures. By way of example, and not limitation, such architectures can include one or more of Industry Standard Architecture (ISA®) bus, Micro Channel Architecture (MCA®) bus, Enhanced ISA (EISA®) bus, Video Electronics Standards Association (VESA®) local bus, and Peripheral Component Interconnect (PCI) bus.

The system main memory 304, in one embodiment, can include computer system readable media in the form of volatile memory, such as random access memory (RAM) and/or cache memory. By way of example only, a persistent memory storage system 306 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a compact disc-read only memory (CD-ROM) and digital versatile disc-read only memory (DVD-ROM) or other optical media can be provided. In such instances, each can be connected to bus architecture 308 by one or more data media interfaces. As will be further depicted and described below, persistent memory 306 may include at least one program product having a set (e.g., at least one) of program modules that are configured to carry out the functions of various embodiments of the invention.

A program/utility, having a set (at least one) of program modules, may be stored in persistent memory 306 by way of example, and not limitation, as well as an operating system, one or more application programs or applications, other program modules, and program data. Each of the operating system, one or more application programs, other program modules, and program data, or some combination thereof, may include an implementation of a networking environment. Program modules generally may carry out the functions and/or methodologies of various embodiments of the invention as described herein.

The at least one processor 302 is communicatively coupled with one or more network interface devices 316 via the bus architecture 308. The network interface device 316 is communicatively coupled, according to various embodiments, with one or more networks operably coupled with a cloud infrastructure 332. The cloud infrastructure 332, according to the example, includes a storage cloud, which comprises one or more storage servers (also referred to as storage server nodes), and a computation cloud, which comprises one or more computation servers (also referred to as computation server nodes). The network interface device 316 can communicate with one or more networks such as a local area network (LAN), a general wide area network (WAN), and/or a public network (e.g., the Internet). The network interface device 316 facilitates communication between the server node 300 and other server nodes in the cloud infrastructure 332.

A user interface 310 is communicatively coupled with the at least one processor 302, such as via the bus architecture 308. The user interface 310, according to the present example, includes a user output interface 312 and a user input interface 314. Examples of elements of the user output interface 312 can include a display, a speaker, one or more indicator lights, one or more transducers that generate audible indicators, and a haptic signal generator. Examples of elements of the user input interface 314 can include a keyboard, a keypad, a mouse, a track pad, a touch pad, and a microphone that receives audio signals. The received audio signals, for example, can be converted to electronic digital representation and stored in memory, and optionally can be used with voice recognition software executed by the processor 302 to receive user input data and commands.

A computer readable medium reader/writer device 318 is communicatively coupled with the at least one processor 302. The reader/writer device 318 is communicatively coupled with a computer readable medium 320. The server node 300, according to various embodiments, can typically include a variety of computer readable media 320. Such media may be any available media that is accessible by the computer system/server 300, and it can include any one or more of volatile media, non-volatile media, removable media, and non-removable media.

Computer instructions 307 can be at least partially stored in various locations in the server node 300. For example, at least some of the instructions 307 may be stored in any one or more of the following: in an internal cache memory in the one or more processors 302, in the main memory 304, in the persistent memory 306, and in the computer readable medium 320.

The instructions 307, according to the example, can include computer instructions, data, configuration parameters, and other information that can be used by the at least one processor 302 to perform features and functions of the server node 300. According to the present example, the instructions 307 include a BestImputer software module 324, one or more data imputation methods 326, one or more end-to-end prediction task methods 328, and a set of configuration parameters that can be used by the BestImputer software module 324 and related methods 326, 328, as has been discussed above. Additionally, the instructions 307 can include server node configuration data.

The at least one processor 302, according to the example, is communicatively coupled with a History Storage and a Data Sets Storage 322 (also referred herein as the DARR 322). The DARR 322 can store data for use by the BestImputer 324 and related methods 326, 328, which can include at least a portion of one or more data sets, and history information which is empirical evidence of prediction accuracy and execution times, for multiple data imputation algorithms and parameter settings. Various functions and features of one or more embodiments of the present invention, as have been discussed above, may be provided with use of the data stored in the DARR 322.

Example Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases

automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

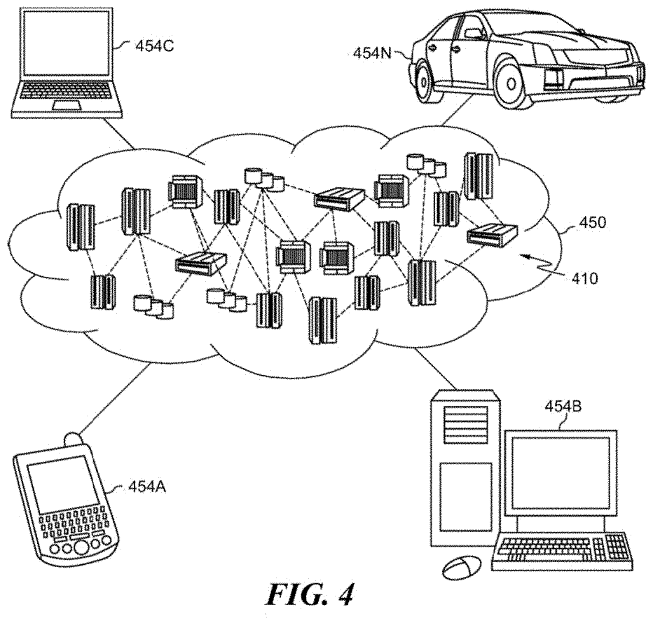

Referring now to FIG. 4, an illustrative cloud computing environment 450 is depicted. As shown, cloud computing environment 450 comprises one or more cloud computing nodes 410 with which local computing devices used by cloud consumers, such as, for example, personal digital assistant (PDA) or cellular telephone 454A, desktop computer 454B, laptop computer 454C, and/or automobile computer system 454N may communicate. Nodes 410 may communicate with one another. They may be grouped (not shown) physically or virtually, in one or more networks, such as Private, Community, Public, or Hybrid clouds, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 4 are intended to be illustrative only and that computing nodes 410 and cloud computing environment 450 can communicate with any type of computerized device over any type of network and/or network addressable connection (e.g., using a web browser).

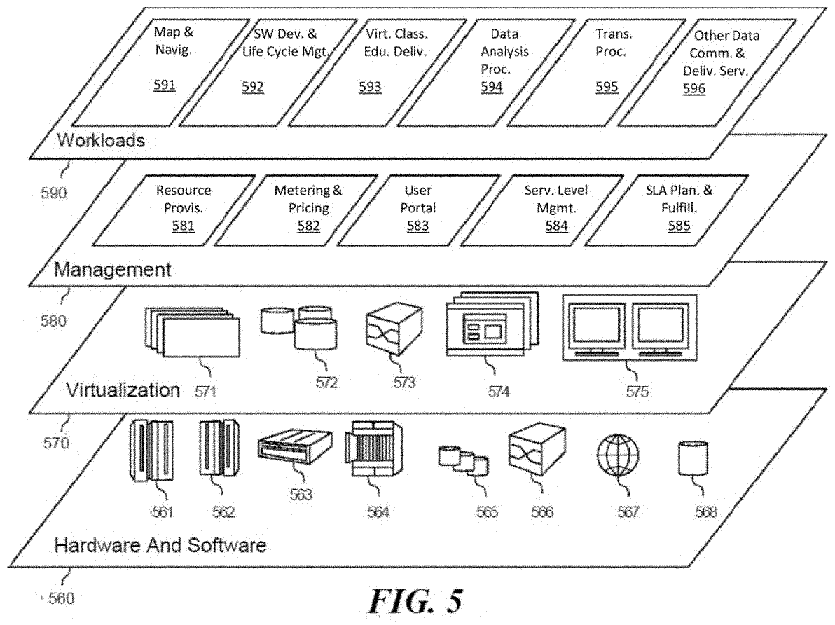

Referring now to FIG. 5, a set of functional abstraction layers provided by cloud computing environment 450 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking of resources which are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; virtual classroom education delivery 593; data analytics processing 594; transaction processing 595; and other data communication and delivery services 596. Various functions and features of the present invention, as have been discussed above, may be provided with use of a server node 300 communicatively coupled with a cloud infrastructure 332, which can include a storage cloud and/or a computation cloud.

### NON-LIMITING EXAMPLES

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a Memory Stick®, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk®, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the functions/acts specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present specification may describe components and functions implemented in the embodiments with reference to particular standards and protocols, the invention is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this invention. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Although only one processor is illustrated for an information processing system, information processing systems with multiple central processing units (CPUs) or processors can be used equally effectively. Various embodiments of the present invention can further incorporate interfaces that each includes separate, fully programmed microprocessors that are used to off-load processing from the processor. An operating system included in main memory for a processing system may be a suitable multitasking and/or multiprocessing operating system, such as, but not limited to, any of the Linux®, UNIX®, Windows®, and Windows® Server based operating systems. Various embodiments of the present invention are able to use any other suitable operating system. Various embodiments of the present invention utilize architectures, such as an object oriented framework mechanism, that allow instructions of the components of the operating system to be executed on any processor located within an information processing system. Various embodiments of the present invention are able to be adapted to work with any data communications connections including present day analog and/or digital techniques or via a future networking mechanism.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The terms “communicatively coupled” or “communicatively coupling” include, but are not limited to, communicating electronic control signals by which one element may direct or control another. The term “configured to” describes hardware, software or a combination of hardware and software that is set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. Any suitably configured processing system is similarly able to be used by embodiments herein, for example and not for limitation, a personal computer, a laptop personal computer (laptop PC), a tablet computer, a smart phone, a mobile phone, a wireless communication device, a personal digital assistant, a workstation, and the like. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed.

The description of the present application has been presented for purposes of illustration and description, but is not intended to be exhaustive or limited to the invention in the form disclosed. Many modifications and variations will be apparent to those of ordinary skill in the art without departing from the scope of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for efficiently determining a best imputation algorithm from a plurality of imputation algorithms comprising:
providing a plurality of imputation algorithms;
providing a time parameter tmax to limit an amount of time spent determining a best imputation algorithm;
maintaining past information i on accuracy and execution time for at least one of the imputation algorithms;
using said information i to compute a utility score for each of the at least one of the imputation algorithms; and
testing imputation algorithms and associated parameters in an order based on said utility scores.

2. The method of claim 1 further comprising:
providing a time parameter tmax(i) for at least one imputation algorithm i to limit an amount of time spent executing algorithm i to determine a best imputation algorithm.

3. The method of claim 1 wherein an amount of time is one of a wall clock time and a cpu time.

4. The method of claim 1 further comprising the step of
ceasing to test data imputation algorithms in response to a time spent determining a best imputation algorithm equaling or exceeding tmax.

5. The method of claim 1 further comprising the step of
ceasing to test data imputation algorithms in response to a time spent determining a best imputation algorithm equaling or exceeding tmax—t3 for a threshold t3.

6. The method of claim 1 further comprising the step of
stopping a data imputation algorithm before it has completed in response to a time spent determining a best imputation algorithm equaling or exceeding tmax.

7. A computer program product for efficiently determining a best imputation algorithm from a plurality of imputation algorithms, the computer program product comprising a computer readable storage medium having computer readable program code embodied therewith, the computer readable program code including computer instructions, where a processor, responsive to executing the computer instructions, performs operations comprising:
providing an error threshold e for an imputation algorithm;
maintaining past information i on prediction accuracy for the imputation algorithm;
identifying a data set d1 from i and a subset s1 of d1 wherein an average error for running the imputation algorithm on s1 differs from an average error for running the imputation algorithm on d1 by an amount not exceeding e; and
using s1 or a size of s1 to determine prediction accuracy for the imputation algorithm on a data set d2.

8. The computer program product of claim 7 wherein data set d2 is identical to data set d1 and the imputation algorithm is run on data set s1.

9. The computer program product of claim 7 wherein data set d2 is different from data set d1 and the imputation algorithm is run on a subset of d2 of size round(size(d2)*size(s1)/size(d1)).

10. The computer program product of claim 7 wherein errors are computed using at least one of mean average errors and mean squared errors.

11. The computer program product of claim 7 wherein s1 is a smallest subset of d1 for which i includes an average error for running the imputation algorithm on s1 and the average error for running the imputation algorithm on s1 differs from an average error for running the imputation algorithm on d1 by an amount not exceeding e.

12. The computer program product of claim 7 wherein at least some of the operations for efficiently determining a best imputation algorithm from a plurality of imputation algorithms are implemented in a cloud service.

13. The computer program product of claim 7 wherein the operations further comprise:
providing a plurality of imputation algorithms; and
providing a time parameter tmax to limit an amount of time spent determining a best imputation algorithm.

14. The computer program product of claim 13 wherein the operations further comprise:
maintaining past information i on accuracy and execution time for at least one of the imputation algorithms; and
using said information i to compute a utility score for each of the at least one of the imputation algorithms.

15. The computer program product of claim 14 wherein the operations further comprise:
testing imputation algorithms and associated parameters in an order based on said utility scores.

16. The method of claim 1 wherein at least some of the method steps are implemented in a cloud service.

17. The method of claim 1 further comprising:
providing an error threshold e for an imputation algorithm; and
maintaining past information i on prediction accuracy for the imputation algorithm.

18. The method of claim 17 further comprising:
identifying a data set d1 from i and a subset s1 of d1 wherein an average error for running the imputation algorithm on s1 differs from an average error for running the imputation algorithm on d1 by an amount not exceeding e; and
using s1 or a size of s1 to determine prediction accuracy for the imputation algorithm on a data set d2.

19. A processing system comprising:
a server for a cloud computing infrastructure communicatively coupled to a network interface;
one or more processors communicatively coupled to the server;
a memory coupled to a processor of the one or more processors; and
a set of computer program instructions stored in the memory, wherein the processor, responsive to executing computer program instructions, performs a method comprising:
providing a plurality of imputation algorithms;
selecting a plurality of criteria to evaluate the imputation algorithms wherein each criterion is quantified with a number;
a user providing a method for computing a score from the plurality of criteria;
using the method provided by the user to calculate a score for each imputation algorithm.

20. The processing system of claim 19 wherein at least some of the computer program instructions are performed by a cloud service.
